(19) United States
(12) Patent Application Publication
(10) Pub. No.: US 2007/0168295 A1
(43) Pub. Date: Jul. 19, 2007

(54) Verification method for personal credit purchases

(76) Inventor: Chao-Hung Wu, Hsintien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/332,318

(22) Filed: Jan. 17, 2006

(51) Int. Cl. G06Q 99/00; H04L 9/00

(52) U.S. Cl. 705/64; 705/75

(57) ABSTRACT

A verification method for personal credit purchases is disclosed. The method utilizes a user data, at least one prerecorded AV data and a user status authentication data stored on a central server to verify of a personal credit purchase. The method of the present invention avoids illegal use of the card by unauthorized individuals.

### BACKGROUND OF THE INVENTION

1. Field of the Invention

The present invention relates to a verification method, and more particularly to a verification method for personal credit purchases.

2. Description of the Prior Art

In recent decades consumers have changed their spending habits from traditional cash based payments to making more and more purchases using their credit cards. In more recent years, there has also been a shift from purchasing goods from a store to buying over the Internet. However, in regard especially to Internet purchases, many consumers have displayed a marked reluctance to use their credit card due to security concerns. In response, many software companies have researched methods for verifying a cardholder's identity and various means of encrypting information sent over the Internet.

Many patents have been proposed for enhancing personal data security. TW patent No. 460849, “Method of verifying credit card owner” discloses a method with two steps for achieving the objectives of avoiding counterfeiting, copying or illegal use. The first step involves the credit card owner receiving a key code before using the credit card. The key code is then matched with an authentication unit.

TW patent No. 473681, “Method of secure payment for on-line transactions” discloses a method that provides a secure line to transfer funds between the parties involved. Reference is made to FIG. 1, which is a schematic diagram showing the system for secure payment of on-line transactions. The system comprises a purchase terminal 10, a store website 12 and a payment computer 14.

TW patent No. 200415902, “Personal identification information integrated device” discloses a verification system that combines a banking transaction card and a credit card. The system uses a biology characteristic collector, a banking transaction card and a credit card authorization system for completing the card owner status identity mechanism. Reference is made to FIG. 2, which is a schematic diagram showing the method for a personal identification information integrated device applied for a banking transaction card mechanism. The system comprises a personal identification information integrated device 20, a biology characteristic database 22, a remote authorization system 24, a card-reading device 26 and a biology characteristic collector 28. The personal identification information integrated device 20 includes a transmission integrated module 200 and a biology characteristic process module 202.

TW patent No. 200421147, “System for credit transactions using fingerprint information and method for the same” discloses a system for using fingerprints to verify a purchaser's identity in regard to credit transactions. The method enhances the ability of a card owner to identify themselves. Reference is made to FIG. 3, which is a schematic diagram showing the system. The system comprises at least one terminal 30, at least one user identification unit 32, a fingerprint register unit 34, a management server 36 and a transaction acceptability judgment unit 38.

TW patents No. 460849 and 473681 include many deficiencies that allow for security problems to arise. Hackers can still access transactional information and through various methods even gain access to an individual's account. TW patents No. 200415902 and 200421147 increase security through biology characteristic recognition. However, they still leave credit card information vulnerable to being intercepted during transmission.

### SUMMARY OF THE INVENTION

An object of the present invention is to provide a verification method for credit cards. The method prerecords status data provided by the user allowing it to be compared with the user at the point of purchase.

For achieving the object above, the present invention provides a verification method for personal credit purchase between a user, a purchase terminal and an authorization terminal. The method comprises: prerecording status authentication data having at least one audio-visual (AV) data of the user and storing the data on a central server of the authorization terminal; receiving personal status recognition data provided by the user via a receiver terminal system of the purchase terminal; searching the status authentication data stored on the central server of the authorization terminal in accordance with the personal status recognition data; transmitting the status authentication data from the central server to the receiver terminal system; matching the status authentication data and the at least one AV data with the user; and performing verification of a personal credit purchase.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

FIG. 1 is a schematic diagram showing the method for secure payment for an on-line transaction of the prior art;

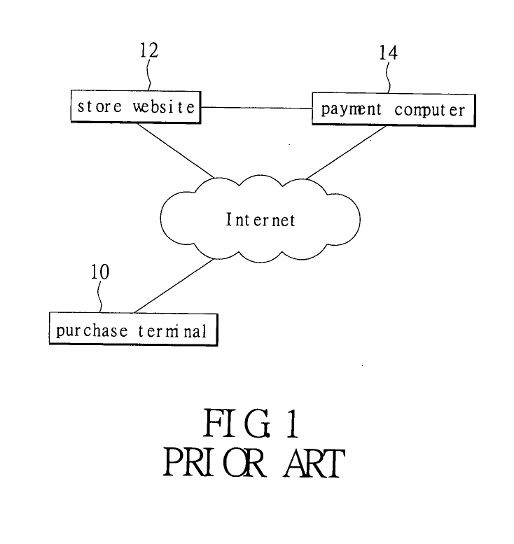

FIG. 2 is a schematic diagram showing the method for a personal identification information integrated device applied to a banking transaction card mechanism of the prior art;

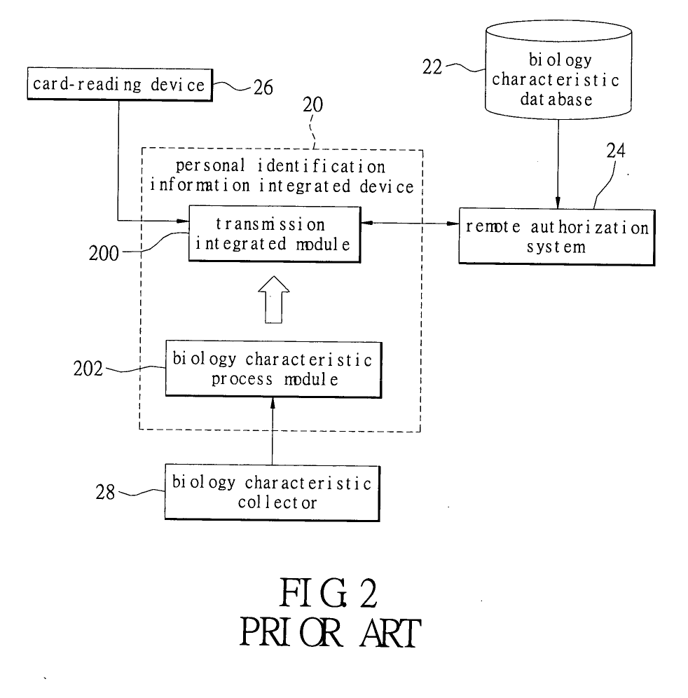

FIG. 3 is a schematic diagram showing the method for a credit transaction using fingerprint information of the prior art;

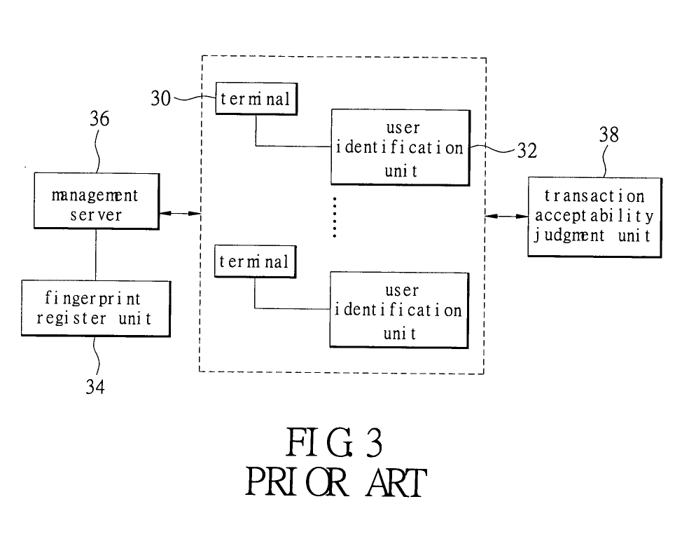

FIG. 4 is a schematic view showing the verification system for a personal credit purchase of the present invention; and

FIG. 5 is a flow chart showing the verification method for a personal credit purchase of the present invention.

### DETAILED DESCRIPTION OF THE PREFERRED EMBODIMENTS

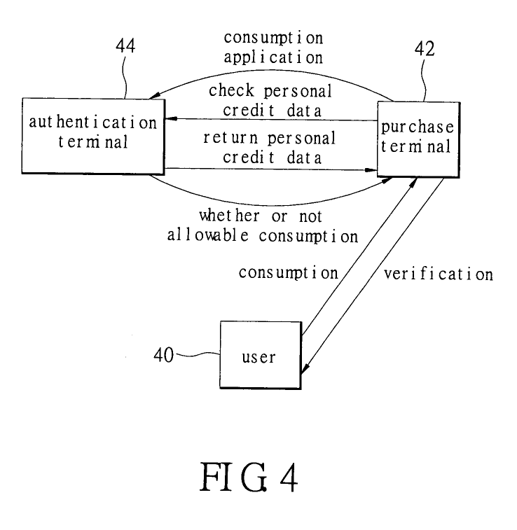

Reference is made to FIG. 4, which is a schematic view showing the verification system for a personal credit purchase of the present invention. The system has two main functions. Firstly it is able to verify the identity of user. Secondly, it allows a customer to make purchases from a store or over the Internet. The present invention comprises an authentication terminal, a purchase terminal and a user. The user 40 must firstly perform a prerecorded act (including registering personal data and personal status authentication data) using the authentication terminal 44. The prerecorded act uses a camera to catch at least one AV data and at least one static image of the user 40 stored on a central server (not shown) of the authentication terminal 44. When the user 40 wants to use a purchase terminal 42, the purchase terminal 42 transmits the status data provided by the user 40 to the central server for retrieving the user 40 data via the Internet. The central server transmits the at least one AV data to the purchase terminal 42. The purchase terminal 42 then verifies the authenticity of the user 40 in accordance with the at least one AV data. The purchase terminal 42 then receives a cost of purchase data inputted by the user 40 and sends the data to the authentication terminal 44. The authentication terminal 44 verifies whether the cost of purchase is within the user's limit. If the purchase is allowed, the authentication terminal 44 returns a confirmation message to the purchase terminal 42. The user 40 must them sign a receipt and the purchase terminal 42 takes money from the authentication terminal 44 in accordance with the receipt. The purchase terminal 42 may be a physical store or an Internet store.

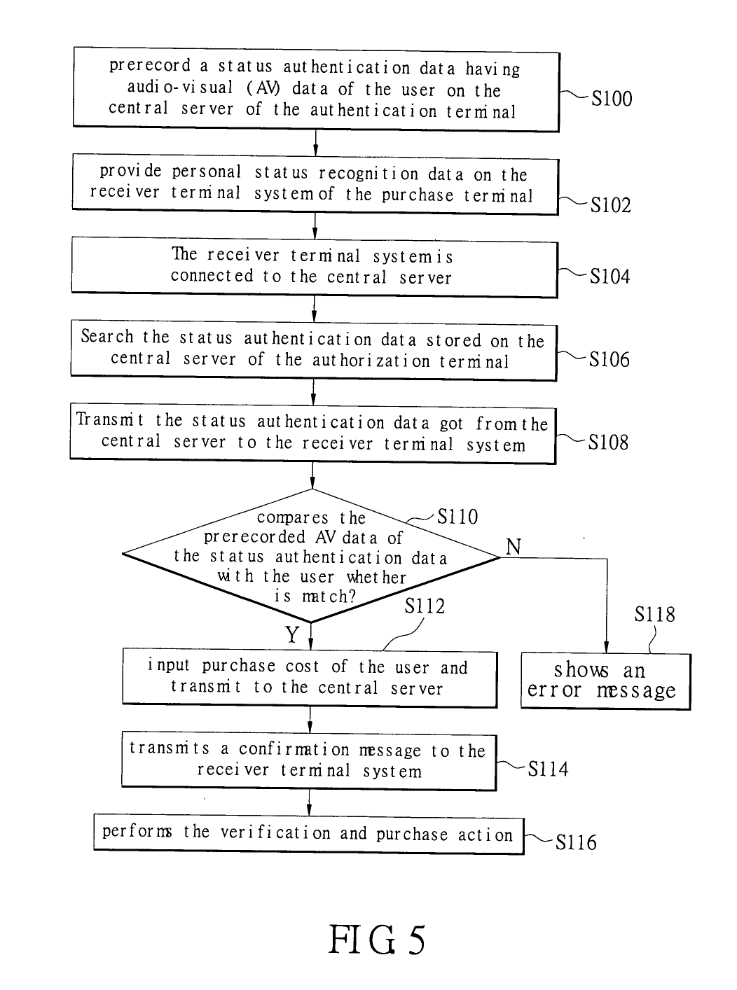

Reference is made to FIG. 5, which is a flow chart showing the verification method for personal credit purchases of the present invention. The method has two main functions. Firstly it is able to verify the identity of user. Secondly, it allows a customer to make purchases from a store or over the Internet. The present invention comprises between an authentication terminal, a purchase terminal and a user. The user 40 makes a purchase using the purchase terminal 42. The user 40 must prerecord status authentication data including at least one audio-visual (AV) data on the central server of the authentication terminal 44 (S100). In S100, the user 40 inputs user status authentication data, which includes a prerecording of at least one AV data, the status authentication data, and user data. The user data may include a name, a phone number, an address, an identification number, family data, an e-mail address, and/or school records. The at least one AV data includes at least one static image and at least one motion AV data. The at least one static image may be a photograph. The at least one motion AV data may be a recording of a section of a personal motion AV data, such as a multi-angled personal motion AV. The user authentication data may be a fingerprint image, a signature, or a stamp/namechop (including a personal signature combined with a password), a password or other authentication data. The at least one motion AV data is made using an audio/video input device that records an image and voice of the user 40. The audio/video input device includes a microphone and/or a video camera or other input device.

After the user 40 has selected a purchase, the user 40 provides personal status recognition data to the receiver terminal system of the purchase terminal (S102). The user provides the personal status recognition data for comparison with speech characteristics or other characteristics, such as personal data or a signature. The receiver terminal system is connected to the central server via a network (S104). The network may be an Ethernet network (such as an IEEE 802.11 x) or a wireless network. The status authentication data stored on the central server of the authorization terminal is searched in accordance with the personal status recognition data (S106). The central server compares the personal status recognition data with the status authentication data to verify the user. The status authentication data received from the central server is then transmitted to the receiver terminal system (S108). The status authentication data includes not only the user status authentication data but also a cost purchase.

A salesclerk in a store using the receiver terminal system of the present invention compares the prerecorded AV data of the status authentication data with the user's data (S110). To avoid illegal use of the user's personal data, the salesclerk of the store using the receiver terminal system uses three types of verification. First, the salesclerk compares the status authentication data (which comprises the user data and the user status authentication data) with the personal status recognition data. Second, the salesclerk compares status authentication data (which comprises the user data and the prerecorded AV data) with the personal status recognition data. Third, the salesclerk compares the status authentication data (which comprises the user data, the prerecorded AV data, and the user status authentication data) with the personal status recognition data. The above manner of verification can be used for an individual or any other entity.

The receiver terminal system shows an error message when the comparing result is negative (S118). Immediately upon discovering the illegal use of a card by the customer terminal user, the salesclerk should notify the police to apprehend the unauthorized user.

The receiver terminal system inputs the purchase cost and transmits it to the central server once the user's identity has been verified (S112). The central server then checks whether the purchase cost is within the user's limit. If the purchase is allowed, the central server transmits a confirmation message to the receiver terminal system (S114). The purchase terminal then requests a signature from the user. The purchase terminal can use the user's signature and a receipt to confirm that the authorization terminal should pay the purchase terminal. Finally, the salesclerk completes the sales transaction (SI 16).

The status authentication data of the present invention includes the user data, the prerecorded AV data and the user status authentication data. The prerecorded AV data further comprises the at least one static image (such as a photograph) and the at least one motion AV data (such as a multi-angled personal motion AV).

The identity of the card owner can be confirmed by checking that the user's information and appearance is in accordance with the card information. However, the present invention does not check whether the user is the card owner in the same manner as the prior art. Through the card has the user's photograph, the customer terminal cannot verify if the user is the card owner. The photograph of the card can be falsified via image-editing technology. In a similar way, the signature of the card can be falsified, too. No matter how the encryption technology of the card is enhanced, it cannot fully protect the card from being altered in some way which makes illegal use possible. However, the present invention is protected from falsification because verification using the method of the present invention must be directly confirmed by the user rather then by the card information and the information required to verify the user's identity is prerecorded by the user on the central server. So, the original information is absolutely true. The method of the present invention is different from checking a password, a signature or other card information of the prior art.

The user can use the method of the present invention to make purchases at a customer terminal, no matter whether or not the user has actually brought along their card (such as a credit card, a chip card or any other card for proving their identity). The present invention provides a novel verification method different from the current verification method. The user must record the prerecorded AV data, the user status authentication data and the user data on the authorization terminal. The receiver terminal system transmits personal status recognition data to the central server, then the central server finds the prerecorded AV data in accordance with the personal status recognition data and replies to the receiver terminal system. Next, the receiver terminal system verifies the user on the customer terminal in accordance with the prerecorded AV data. The novel verification method uses the prerecorded AV data to verify the user, as opposed to using the card information to verify the user.

The method of the present invention can also be applied for verifying transactions over the Internet. This is the second embodiment of the present invention. The user provides the card number and personal data to make a purchase. In the prior art, the status verification checks the card number but an unauthorized user can get the card number and the personal information via various methods. The verification methods of the prior art are useless for the card owner and offered inadequate protection to ensure that an unauthorized user could not use a card.

The user pre-stores the status authentication data on the central server on the authorization terminal. A camera is disposed on the customer terminal and a user terminal. The remote customer terminal requests the user to provide personal data and user status authentication data to verify the user. If the customer terminal cannot verify the user in accordance with the personal data and the user status authentication data, then the customer terminal transmits a request message to the central server. The central server finds the prerecorded AV data, the personal data and personal status recognition data therein. The remote customer terminal uses a network video to compare the prerecorded AV data with the user and compares the personal data and the personal status recognition data simultaneously. If the result is negative, the remote customer terminal stops the purchase. If the compare result is positive, the remote customer terminal verifies the user's status and the purchase.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A verification method for personal credit purchases involving a user, a purchase terminal and an authorization terminal, comprising:
prerecording status authentication data having at least one audio-visual (AV) data of the user which is then stored on a central server of the authorization terminal;
receiving the personal status recognition data provided by the user via a receiver terminal system of the purchase terminal;
searching the status authentication data stored on the central server of the authorization terminal in accordance with the personal status recognition data;
transmitting the status authentication data from the central server to the receiver terminal system;
comparing the status authentication data and the least one of AV data with the user; and
verifying a personal credit purchase.

2. The method as claimed in claim 1, further comprising prerecording a user status authentication data and a user data of the user and which is then stored on a central server of the authorization terminal.

3. The method as claimed in claim 1, wherein the step of prerecording is performed by an audio/video input device.

4. The method as claimed in claim 3, wherein the audio/video input device is a microphone and a video camera.

5. The method as claimed in claim 1, wherein the status authentication data comprises a user data and a user status authentication data.

6. The method as claimed in claim 1, wherein the at least one AV data includes at least one static image and at least one motion AV data.

7. The method as claimed in claim 6, wherein the at least one static image is a photograph.

8. The method as claimed in claim 6, wherein the at least one motion AV data is a recording of a section of personal motion AV data.

9. The method as claimed in claim 5, wherein the user data includes a name, a phone number, an address, an identification number, family data, an e-mail address, and/or school records.

10. The method as claimed in claim 5,wherein the user status authentication data includes a fingerprint image, a signature and/or a stamp/namechop, a password and other authentication data.

11. The method as claimed in claim 1, further comprising connecting the receiver terminal system to the central server.

12. The method as claimed in claim 11, wherein the step of connecting is completed via an Internet.

13. The method as claimed in claim 1, further comprises comparing the status authentication data, which includes user data, the AV data and the user status authentication data, with the personal status recognition data.

14. The method as claimed in claim 1, wherein the step of comparing the status authentication data further comprises:
inputting a user's purchase cost and transmitting the purchase cost to the central server; and
sending a confirmation message from the central server to the receiver terminal system.

15. The method as claimed in claim 14, further comprising performing a verification action of the personal credit purchase.
